(19) United States
(12) Patent Application Publication
(10) Pub. No.: US 2018/0029406 A1
(43) Pub. Date: Feb. 1, 2018

(54) PROCESS FOR THE PRODUCTION OF STONE MATERIAL MANUFACTURED ARTICLES

(71) Applicant: AROS S.R.L., Affi (VR) (IT)

(72) Inventor: Stefano FIORATTI, Desenzano (BS) (IT)

(21) Appl. No.: 15/546,960

(22) PCT Filed: Jan. 19, 2016
(86) PCT No.: PCT/IB2016/050239

§ 371 Date: Jul. 27, 2017

(30) Foreign Application Priority Data
Jan. 29, 2015 (IT) ITVR2015A000016

(51) Int. Cl. B44C 5/04; B32B 3/16; B32B 38/00; B32B 9/00; B32B 9/04; B28D 1/32; B32B 5/18

(52) U.S. Cl. CPC B44C 5/0438; B28D 1/322; B32B 3/16; B32B 5/18; B32B 9/002; B32B 9/005; B32B 9/046; B32B 38/0004; B32B 2038/0024; B32B 2255/26; B32B 2266/0278; B32B 2307/712; B32B 2451/00; B32B 2479/00; B32B 2607/00; B32B 2307/402

(57) ABSTRACT

Process for the realization of manufactured articles in stone material, characterized by comprising the following steps of: providing a block or flat sheet of said stone material, and gluing a support in a flexible material on a surface of said sheet, carrying out the cutting or sectioning of said sheet to obtain a laminated panel with a determined minimum thickness, carrying out the winding of the mentioned laminated panel on a roll or similar curved surface to obtain the crushing of said panel into irregular chunks or parts; carrying out the impregnation or spreading on said crushed panel with polymeric materials or thermosetting resins; recomposing the planarity of said impregnated panel thus obtained.

The present invention relates to a process for the realization of manufactured articles in stone material.

In particular, the invention is advantageously employed to make natural stone and sheet-like manufactured articles, such as, for example, ceramic materials, natural marbles or composite marbles, i.e. marbles with zones in resin and quartzes, to which the following description will make explicit reference without thereby losing generality.

Stone laminate products in natural stone, typically slate, sandstone or ceramic (for example, Laminam®) are currently available and affordable on the market, which have also very small thicknesses (3 to 5 mm).

In particular, the slate, as a variety of metamorphic allochthonous rock of sedimentary origin, is a rock classified as soft or semi-hard rock, and it is defined by a variety of clay-calcareous shale easily dividable in thin, flat and light slabs or sheets, which are impermeable and resistant to the weather, arising from the low metamorphism of sedimentary rocks formed by deposition of a very fine silt (marl) due to erosion of ancient reliefs.

Such laminated products are generally made by gluing of tissues impregnated or impregnable with an adhesive material, adapted then to be “tear” eliminated allowing the delamination of the rock itself.

There are also other materials which lend themselves to the above delamination technology, materials such as sedimentary rocks easy to be disgregated superficially under the mechanical action of traction, or other ceramic materials obtained by pressing and subsequent firing to obtain ceramic rigid panels (Laminam®).

The technology of stone field has the limit that it can be used on material with low compactness or “prone” to be delaminated, in the case of ceramic laminae the material is obtained by the classic process of the production of tiles or slabs, along with the low thickness.

Another technology that is emerging on the market concerns the manufacture of ceramic sheets having low thickness (3-6 mm), which are completely identical to the natural stones because made by laser printing technology capable of reproducing with an extreme high fidelity the appearance of the stone. Such sheets have a surface coating from molten glass that allows an aesthetic effect comparable to the natural stones.

The object of the present invention is to provide a process for the realization of manufactured articles in stone materials having low thickness, which is alternative and advantageous compared to the above existing technologies currently on the market.

In particular, an object of the present invention relates to the realization of manufactured articles in sheet, tape or laminates, usually with excellent mechanical seal characteristics and high aesthetic aspects.

The structural and functional characteristics of the present invention and its advantages over the known art will be clearer and more evident from the claims below.

The novel process, which can be made also continuously, comprises the steps of:
arranging a block or flat sheet of natural stone, or alternatively of ceramic materials, marbles or composite marbles, i.e. marbles with zones in resin and quartzes;
   gluing a support sheet in a flexible material on a surface of such sheet. The mentioned support in flexible material includes preferably, but without limitation, one of the following: an insulating foam sheet or the like; Velcro® o Velcro®OneWrap@; a sandwich panel in an insulation component formed from a polyiso foam, expanded without the use of CFC or HCFC, coated on both sides with saturated glass veil (Stiferite®); a rigid polyurethane foam (Corafoam®); or like flexible materials. The following gluing materials are suggested: epoxy systems Limpid or resins Glaxs, both produced by Tenax S.p.A.
   carrying out the cutting or sectioning of said sheet to obtain a laminated panel with a determined minimum thickness, said cutting being made preferably, but without limitation, by disc/saw means or the like, or alternatively by diamond cutting wire means;
   carrying out the winding of the mentioned laminated panel on a roll or similar curved surface to obtain the crushing of the panel itself into chunks or parts having a substantially irregular shape;
   carrying out the impregnation or spreading on such crushed panel with the use of polymeric materials or thermosetting resins, such as epoxy resins, acrylic polyester resins or the like, also being variously stained;
   recomposing the planarity of the impregnated panel thus obtained.

In this way, a laminated panel is obtained having a limited thickness and a very low weight, provided with excellent characteristics of mechanical hardness and strength, with high aesthetic aspects and with chrome effects which make the use of the panels laminated thus obtained advantageous as laying and coating element, e.g. in profile coatings, columns, corrugated materials or in particular for furniture elements, washbasins, shower trays, bathtubs, tops of kitchens, and the like.

Such aesthetic and ornamental or value aspects may also be highlighted by adding to the above described process the further step of carrying out the brightening or painting of the aforementioned laminated panel.

Further advantages of the laminated panel thus obtained are the possibility of gluing on existing flat surfaces without removing the existing floor due to the low thickness, the possibility to couple to the panel itself for a thermal insulation that allows a high energy saving, the possibility of easy removal in case of using quick release systems such as velcro and the like, the use also for external coatings with low weight with the reduction of accidents during the laying or due to detachments, and the optimal yield per square meter of natural stone material.

1. Process for the production of stone material manufactured articles, characterized in that it comprises the following steps: preparing a solid or flat plate of said stone material and pasting on a surface of said plate a support of a flexible material, cutting or sectioning of said plate so as to obtain a laminate panel of a determined minimum thickness, winding said laminate panel on a roller or equivalent curved surface so as to obtain the crushing of said panel in pieces or irregular parts; realizing the impregnation or coating of said crushed panel with polymeric materials or thermosetting resins; recomposing the planarity of said panel.

2. Process according to claim 1, characterized in that it comprises the further step of performing polishing or painting of said laminate panel.

3. Process according to claim 1, characterized in that the said flat plate is made of natural stone.

4. Process according to claim 1, characterized in that the said flat plate is made of ceramic material.

5. Process according to claim 1, characterized in that the said flat plate is made of marble or marble composite with resins and quartzes.

6. Process according to claim 1, characterized in that the said cutting is made using disk means.

7. Process according to claim 1, characterized in that the said cutting is made using diamond cutting wire means.

8. Process according to claim 1, characterized in that the said flexible support comprises an insulation foam sheet or a rigid polyurethane foam or equivalent material.

9. Process according to claim 1, characterized in that the said resins include epoxy resins, polyester, acrylic or the like, also variously colored.

10. Manufactured article of stone material obtained by the process according to claim 1.
